(19) United States
(12) Patent Application Publication
(10) Pub. No.: US 2025/0028260 A1
(43) Pub. Date: Jan. 23, 2025

(54) MANUFACTURING METHOD OF ELECTROSTATIC CHARGE IMAGE DEVELOPING CARRIER, AND MANUFACTURING METHOD OF ELECTROSTATIC CHARGE IMAGE DEVELOPER

(71) Applicant: FUJIFILM Business Innovation Corp., Tokyo (JP)

(72) Inventor: Takeshi TANABE, Kanagawa (JP)

(73) Assignee: FUJIFILM Business Innovation Corp., Tokyo (JP)

(21) Appl. No.: 18/735,173

(22) Filed: Jun. 5, 2024

(30) Foreign Application Priority Data
Jul. 19, 2023 (JP) 2023-117859

(51) Int. Cl. G03G 9/083; G03G 9/087

(52) U.S. Cl. CPC G03G 9/0839; G03G 9/08797

(57) ABSTRACT

A manufacturing method of an electrostatic charge image developing carrier, includes a step A in which a mixed solution containing a resin having a glass transition temperature Tg and a solvent is mixed with magnetic particles in a mixer, the mixture is heated to evaporate the solvent to form a resin coating layer on a surface of the magnetic particles so that resin-coated magnetic particles are obtained, and the resin-coated magnetic particles are crushed in a state of being maintained at a temperature T_{A}; a step B in which the resin-coated magnetic particles after the step A are fluidized in a fluidized bed equipment in a state of being maintained at a temperature T_{B}; and a step C in which the resin-coated magnetic particles after the step B are cooled, in which the temperature T_{A} and the temperature T_{B} are each independently equal to or higher than the glass transition temperature Tg−20° C. and equal to or lower than the glass transition temperature Tg+50° C.

### CROSS-REFERENCE TO RELATED APPLICATIONS

This application is based on and claims priority under 35 USC 119 from Japanese Patent Application No. 2023-117859 filed Jul. 19, 2023.

### BACKGROUND

### (i) Technical Field

The present disclosure relates to a manufacturing method of an electrostatic charge image developing carrier and a manufacturing method of an electrostatic charge image developer.

### (ii) Related Art

JP2022-147738A discloses a manufacturing method of an electrostatic charge image developing carrier, including a coating step of adding a coating liquid that contains a resin and a solvent and magnetic particles to a mixer having an agitating blade to form a resin coating layer on a surface of the magnetic particles, and taking out a carrier having the resin coating layer from the mixer, in which, in the coating step, an agitating condition from a start of heating in the mixer to evaporate and dry the solvent to taking out from the mixer satisfies requirements of the following expression 1 and the following expression 2.

0.2≤Circumferential speed πDN (m/s) of the agitating blade≤2.0 Expression 1

1×10³<Agitating work amount (circumferential speed×agitating time T)≤4×10³ Expression 2

In the expressions 1 and 2, D represents a diameter (m) of the agitating blade, N represents a rotation speed (rps) of the agitating blade, and T represents a time(s) from a point in time when a load power value of the agitating blade before drying of the solvent rises as the drying proceeds, and as the drying is completed, the load power value is decreased to 1.3 times or less a value before the drying, to a point in time when the agitating in the mixer is terminated.

JP1996-234499A discloses a manufacturing method of an electrophotographic carrier consisting of a carrier core material and a resin that coats a surface of the carrier core material, the manufacturing method being characterized in that the carrier is homogenized using an air flow classifier.

### SUMMARY

Aspects of non-limiting embodiments of the present disclosure relate to a manufacturing method of an electrostatic charge image developing carrier, the manufacturing method including a step A in which a mixed solution containing a resin having a glass transition temperature Tg and a solvent is mixed with magnetic particles in a mixer, the mixture is heated to evaporate the solvent to form a resin coating layer on a surface of the magnetic particles so that resin-coated magnetic particles are obtained, and the resin-coated magnetic particles are crushed in a state of being maintained at a temperature T_{A}, a step B in which the resin-coated magnetic particles after the step A are fluidized in a fluidized bed equipment in a state of being maintained at a temperature T_{B}, and a step C in which the resin-coated magnetic particles after the step B are cooled, in which color haze suppression property of an image to be obtained is excellent as compared with a case in which the temperature T_{A} is lower than the glass transition temperature Tg−20° C. and the step B is not performed, or a case in which the temperature T_{B} is lower than the glass transition temperature Tg−20° C. and higher than the glass transition temperature Tg+50° C.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided a manufacturing method of an electrostatic charge image developing carrier, including: a step A in which a mixed solution containing a resin having a glass transition temperature Tg and a solvent is mixed with magnetic particles in a mixer, the mixture is heated to evaporate the solvent to form a resin coating layer on a surface of the magnetic particles so that resin-coated magnetic particles are obtained, and the resin-coated magnetic particles are crushed in a state of being maintained at a temperature T_{A}; a step B in which the resin-coated magnetic particles after the step A are fluidized in a fluidized bed equipment in a state of being maintained at a temperature T_{B}; and a step C in which the resin-coated magnetic particles after the step B are cooled, in which the temperature T_{A} and the temperature T_{B} are each independently equal to or higher than the glass transition temperature Tg−20° C. and equal to or lower than the glass transition temperature Tg +50° C.

### BRIEF DESCRIPTION OF THE DRAWINGS

Exemplary embodiment(s) of the present invention will be described in detail based on the following figures, wherein:

FIG. 1 is a view schematically showing a configuration of an example of an image forming apparatus according to the present exemplary embodiment;

FIG. 2 is a view schematically showing the configuration of an example of a process cartridge detachable from the image forming apparatus according to the present exemplary embodiment; and

FIG. 3 is a schematic graph showing a fluctuation of a load power value of an agitating blade and a fluctuation of a temperature in a mixer according to lapse of time in an example of the manufacturing method of an electrostatic charge image developing carrier according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the intended purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acrylic” means at least one of acrylic or methacrylic, and “(meth)acrylate” means at least one of acrylate or methacrylate.

In the present disclosure, carbon black is not included in inorganic particles.

In the present disclosure, an “electrostatic charge image developing toner” is also referred to as “toner”, an “electrostatic charge image developing carrier” is also referred to as “carrier”, and an “electrostatic charge image developer” is also referred to as a “developer”.

### Manufacturing Method of Electrostatic Charge Image Developing Carrier

The manufacturing method of an electrostatic charge image developing carrier according to the present exemplary embodiment is a manufacturing method of an electrostatic charge image developing carrier, including a step A in which a mixed solution containing a resin having a glass transition temperature Tg and a solvent is mixed with magnetic particles in a mixer, the mixture is heated to evaporate the solvent to form a resin coating layer on a surface of the magnetic particles so that resin-coated magnetic particles are obtained, and the resin-coated magnetic particles are crushed in a state of being maintained at a temperature T_{A}; a step B in which the resin-coated magnetic particles after the step A are fluidized in a fluidized bed equipment in a state of being maintained at a temperature T_{B}; and a step C in which the resin-coated magnetic particles after the step B are cooled, in which the temperature T_{A} and the temperature T_{B} are each independently equal to or higher than the glass transition temperature Tg−20° C. and equal to or lower than the glass transition temperature Tg+50° C.

In manufacturing of a carrier using a dip coating method, a step of mixing a mixed solution containing a resin having a glass transition temperature Tg and a solvent with magnetic particles in a mixer, heating the mixed solution to evaporate the solvent to form a resin coating layer on a surface of the magnetic particles and obtain resin-coated magnetic particles, and crushing the resin-coated magnetic particles is included. In a case of obtaining the resin-coated magnetic particles, the solvent is evaporated by heating, and thus the resin-coated magnetic particles are at a temperature close to a glass transition temperature Tg of the resin. Therefore, in a case where the obtained resin-coated magnetic particles are crushed while being cooled, a shear force applied to the resin-coated magnetic particles is likely to cause peeling of the resin coating layer that is not completely fixed to the magnetic particles. Components of coating fragments, such as resin pieces due to the peeled resin coating layer, are developed together with the toner, and in particular, a yellow toner, a clear toner, or the like may generate color haze derived from the components of coating fragments. In order to suppress the occurrence of the color haze of the image to be obtained in view of further increase in quality requirement, it is required to further reduce the components of coating fragments.

In the manufacturing method of an electrostatic charge image developing carrier according to the present exemplary embodiment, a temperature of the resin-coated magnetic particles during the crushing of the resin-coated magnetic particles in which the resin coating layer is formed on the surface of the magnetic particles is set to T_{A}, a temperature of the resin-coated magnetic particles during the fluidizing of the resin-coated magnetic particles after the crushing is set to T_{B}, and then the resin-coated magnetic particles are cooled. The temperature T_{A} and the temperature T_{B} are each independently set to equal to or higher than Tg−20° C. and equal to or lower than Tg+50° C. based on the glass transition temperature Tg of the resin contained in the resin coating layer (or the resin contained in the mixed solution). In a case where the resin-coated magnetic particles are crushed and the crushed resin-coated magnetic particles are fluidized in a state in which such temperature ranges are maintained (a state of not being cooled), and then the resin-coated magnetic particles are cooled, it is presumed that the resin-coated magnetic particles are cooled after fixation of the resin coating layer to the magnetic particles is promoted, and thus the peeling of the resin coating layer is reduced. As a result, in the manufacturing method of an electrostatic charge image developing carrier according to the present exemplary embodiment, the color haze derived from the components of coating fragments is suppressed in the image to be obtained.

Hereinafter, each step in the manufacturing method of an electrostatic charge image developing carrier according to the present exemplary embodiment will be described in detail.

### Step A

The manufacturing method of an electrostatic charge image developing carrier according to the present exemplary embodiment includes a step A in which a mixed solution containing a resin having a glass transition temperature Tg and a solvent is mixed with magnetic particles in a mixer, the mixture is heated to evaporate the solvent to form a resin coating layer on a surface of the magnetic particles so that resin-coated magnetic particles are obtained, and the resin-coated magnetic particles are crushed in a state of being maintained at a temperature T_{A}.

Here, the temperature T_{A} is equal to or higher than the above-described glass transition temperature Tg−20° C. and equal to or lower than the above-described glass transition temperature Tg+50° C.

Hereinafter, in a case of being mentioned as “glass transition temperature Tg”, the “glass transition temperature Tg” refers to a glass transition temperature Tg of the resin contained in the mixed solution (the resin contained in the resin coating layer).

In addition, the “mixed solution containing a resin having a glass transition temperature Tg and a solvent” is also simply referred to as “mixed solution”.

That is, in the step A, in a case where the resin-coated magnetic particles obtained by forming a resin coating layer on a surface of the magnetic particles are crushed, the crushing is performed in a state in which a temperature of the resin-coated magnetic particles is maintained at a temperature T_{A} in a range of equal to or higher than Tg−20° C. and equal to or lower than Tg+50° C. based on the glass transition temperature Tg of the resin contained in the mixed solution (the resin contained in the resin coating layer).

For example, in a case where the glass transition temperature Tg of the resin is 110° C., the temperature T_{A} may be 90° C. or higher and 160° C. or lower.

In the present exemplary embodiment, in a case where the mixed solution contains two or more kinds of resins (in a case where the resin coating layer contains two or more kinds of resins), the glass transition temperature Tg of the resin is a Tg of a resin having a lower glass transition temperature in the two or more kinds of resins.

In addition, in order to maintain the resin-coated magnetic particles at the temperature T_{A}, it is sufficient to adjust a body temperature of the mixer to be the temperature T_{A}.

The temperature T_{A} is measured as follows.

That is, the temperature T_{A} is measured by installing a thermometer in the mixer at a site where the resin-coated magnetic particles can be in contact with the thermometer, or by installing a thermometer in the mixer at a location where the resin-coated magnetic particles are not in contact with the thermometer, to measure an ambient temperature in the mixer.

From the viewpoint of further enhancing the color haze suppression property of the image to be obtained, the temperature T_{A} is, for example, preferably equal to or higher than the glass transition temperature Tg−20° C. and equal to or lower than the glass transition temperature Tg+20° C., and more preferably equal to or higher than the glass transition temperature Tg-15° C. and equal to or lower than the glass transition temperature Tg. In a case where the agitating work amount is too large at a temperature of equal to or higher than the glass transition temperature Tg by 50° C. in the step A, the peeling of the resin coating layer formed on the surface of the magnetic particles easily occurs, so that, for example, the vicinity of Tg is preferable.

From the viewpoint of further enhancing the color haze suppression property of the image to be obtained, for example, it is preferable to perform the crushing with a weak shear force in a case of crushing the resin-coated magnetic particles. Specifically, in the step A, for example, it is preferable that, in a case where a mixer having an agitating blade is used, and the resin-coated magnetic particles are crushed in a state of being maintained at the temperature T_{A}, an agitating condition in the mixer used for the crushing satisfies requirements of the following expression 1 and the following expression 2.

0.2≤Circumferential speed πDN (m/s) of the agitating blade≤2.0 Expression 1

5×10²≤Agitating work amount (circumferential speed πDN×agitating time T)≤1.5 ×10³ Expression 2

In the expressions 1 and 2, D represents a diameter (m) of the agitating blade, N represents a rotation speed (rps) of the agitating blade, and T represents a time(s) from a point in time when the load power value of the agitating blade before drying of the solvent rises as the drying proceeds, and as the drying is completed, the load power value is decreased to 1.3 times or less the value before the drying, to a point in time when the agitating in the mixer is terminated.
π represents a circular constant.

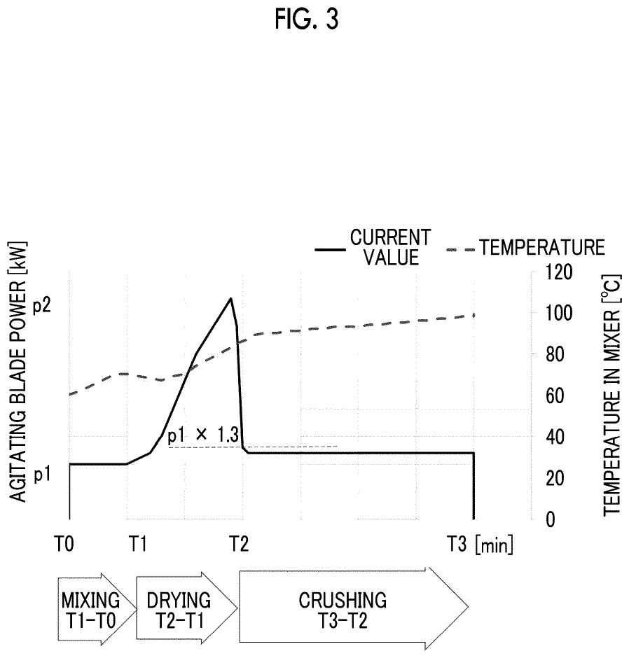

In the step A, for example, it is considered that the load power value of the agitating blade fluctuates as shown in FIG. 3.

FIG. 3 is a schematic graph showing the fluctuation of the load power value of the agitating blade and a fluctuation of a temperature in the mixer according to lapse of time in an example of the manufacturing method of an electrostatic charge image developing carrier according to the present exemplary embodiment.

A vertical axis on the left side of FIG. 3 represents a load power value (kW) of the agitating blade, a vertical axis on the right side represents a temperature (C) in the mixer, and a horizontal axis represents an elapsed time (min).

In T0 shown in FIG. 3, the mixed solution containing the resin having the glass transition temperature Tg and the solvent and the magnetic particles are put into a mixer, and from T0 to T1, the mixed solution and the magnetic particles are in a mixed state. In FIG. 3, from T1 to T2, the solvent contained in the mixed solution is evaporated by heating and, as necessary, reducing the pressure to obtain resin-coated magnetic particles in which the resin coating layer is formed on the surface of the magnetic particles, and then the drying of the resin-coated magnetic particles is completed, and from T2 to T3, the dried resin-coated magnetic particles are crushed. Furthermore, in T3, the agitating in the mixer is terminated, and the carrier is taken out from the mixer.

The fluctuation of the load power value of the agitating blade shown in FIG. 3 is as follows.

From T0 to T1, the load power value of the agitating blade is substantially constant.

From T1 to T2, as the solvent evaporates, a viscosity of the mixture of the mixed solution and the magnetic particles in the mixer is improved, and the load power value of the agitating blade continues to increase until the drying of the resin-coated magnetic particles is completed. In a case where the drying of the resin-coated magnetic particles is completed, the load power value of the agitating blade is rapidly decreased to a value of 1.3 times or less the load power value of the agitating blade from T0 to T1.

From T2 to T3, the load power value of the agitating blade is substantially constant again.

The T is a time from T2 to T3.

In addition, the fluctuation of the temperature in the mixer shown in FIG. 3 is as follows.

From T0 to T1, the temperature is gradually increased to a set temperature (for example, a jacket temperature).

From T1 to T2, the temperature is not stably increased due to vaporization heat of the solvent, but the temperature is gradually increased as a whole as the drying of the resin-coated magnetic particles proceeds.

From T2 to T3, the temperature of the resin-coated magnetic particles is controlled to the set temperature (for example, the jacket temperature) such that the temperature of the resin-coated magnetic particles is within a temperature range of T_{A}.

It is sufficient that the mixer used in the step A is a mixer having an agitating blade, and a known mixer is used, but from the viewpoint of dryness, for example, a vacuum mixer is preferable.

In addition, from the viewpoint of miscibility and color haze suppression property of the image to be obtained, the mixer used in the step A is, for example, preferably a batch-type mixer and more preferably a batch-type vacuum mixer.

Furthermore, as the batch-type mixer, for example, a blade type kneading machine is preferable, and a rotation axis direction of the blade may be vertical or horizontal. Examples of the vertical type include a spiral mixer (manufactured by AICOHSHA MFG. CO., LTD.) and a planetary mixer (manufactured by INOUE MFG., INC.), and examples of the horizontal type include a kneader (manufactured by INOUE MFG., INC.). Among these, from the viewpoint of miscibility and color haze suppression property of the image to be obtained, for example, a biaxial horizontal kneader is particularly preferable.

In addition, for example, it is preferable that the mixer has a temperature control structure that can heat and cool the inside of the mixing tank under a reduced pressure, and has a mechanism that can detect an agitation power value of the agitating blade.

The temperature control structure is not particularly limited, but a jacket structure is preferable.

A shape of the agitating blade in the mixer is not particularly limited, and examples thereof include a Banbury type, a sigma type, a zeta type, a spiral type, and a fishtail type.

The diameter D of the agitating blade is not particularly limited as long as it is a size according to the mixer used. In addition, the diameter D of the agitating blade in the present exemplary embodiment is the maximum outer diameter of a portion through which the agitating blade passes by rotating, in a plane perpendicular to the rotation axis.

From the viewpoint of manufacturing speed of the resin-coated magnetic particles and color haze suppression property of the image to be obtained, the rotation speed N of the agitating blade in the mixer in Examples is, for example, preferably 10 rpm or more and 200 rpm or less, more preferably 15 rpm or more and 150 rpm or less, still more preferably 20 rpm or more and 100 rpm or less, and particularly preferably 40 rpm or more and 60 rpm or less.

A clearance (gap) between the agitated vessel and the agitating blade in the mixer is not particularly limited, and is a size according to the mixer used, but in a case where the clearance is wide, the resin-coated magnetic particles accumulated at the bottom cannot be completely crushed. Therefore, the clearance is determined by the shear force, in addition to the circumferential speed of the agitating blade and the agitating work amount. Accordingly, a narrower clearance is better, but there is a limit to the clearance due to manufacturing constraints of the device, and regarding a clearance between the outer periphery of the agitated vessel and the agitating blade, a value of clearance/diameter of the agitating blade is, for example, preferably 5% or less and more preferably 3.5% or less.

From the viewpoint of color haze suppression property of the image to be obtained, it is necessary to determine the agitating time T a point in time when the load power value of the agitating blade before drying of the solvent rises as the drying proceeds, and as the drying is completed, the load power value is decreased to 1.3 times or less the value before the drying, to a point in time when the agitating in the mixer is terminated, so as to be the expression 2:5×10²≤Agitating work amount (circumferential speed DN×agitating time T)≤1.5×10³, in accordance with the circumferential speed. In the mixer in Examples, the agitating time T is, for example, preferably 5 minutes or longer and 100 minutes or shorter, more preferably 8 minutes or longer and 80 minutes or shorter, still more preferably 15 minutes or longer and 60 minutes or shorter, and particularly preferably 15 minutes or longer and 45 minutes or shorter.

In addition, in the step A, for example, it is preferable to continue the agitating with the agitating blade.

In the step A, in a case where the mixer having an agitating blade is used, and the resin-coated magnetic particles are crushed in a state of being maintained at the temperature T_{A}, for example, it is preferable that the agitating condition in the mixer used for the crushing satisfies a requirement of the following expression 1′, and it is more preferable to satisfy a requirement of the following expression 1″.

0.3≤Circumferential speed πDN (m/s) of the agitating blade≤1.0 Expression 1′

0.5≤Circumferential speed πDN (m/s) of the agitating blade≤0.8 Expression 1″

In addition, in the step A, in a case where the mixer having an agitating blade is used, and the resin-coated magnetic particles are crushed in a state of being maintained at the temperature T_{A}, for example, it is preferable that, the agitating condition in the mixer used for the crushing satisfies a requirement of the following expression 2′. That is, the requirement of the expression 2 is, for example, preferably a requirement of the following expression 2′.

$$Expression {2}^{′}$$

$$7 \times 1 {0}^{2} \leq Agitating work amount ( circumferential speed π DN \times agitating time T ) \leq 1 \times {10}^{3}$$

In the step A, the evaporation of the solvent may be carried out by heating at normal pressure, by heating under reduced pressure, or by heating under reduced pressure, but for example, it is preferable to carry out the evaporation of the solvent by heating under reduced pressure because the solvent can be dried without raising the temperature of the resin equal to or higher than the above-described glass transition temperature Tg of the resin.

An air pressure in the mixer in the step A is not particularly limited, and may be appropriately selected according to the above-described glass transition temperature Tg of the resin and the solvent used, but from the viewpoint of evaporation rate of the solvent and color haze suppression property of the image to be obtained, the air pressure is preferably 0.1 kPa-a or more and 80 kPa-a or less, and more preferably 5 kPa-a or more and 60 kPa-a or less.

kPa-a represents an air pressure (kPa) based on an absolute pressure.

A decompression unit in the mixer is not particularly limited, and a known decompression unit such as a decompression pump is used.

In addition, the evaporated solvent may be collected by a solvent collect unit such as a cooling trap.

In a case where the crushing of the resin-coated magnetic particles in the step A is terminated, the resin-coated magnetic particles are taken out from the mixer.

The temperature of the resin-coated magnetic particles taken out from the mixer is maintained at the temperature T_{A}.

Amounts of the mixed solution and the magnetic particles used in the step A are not particularly limited, and may be appropriately selected depending on a disperser or the like to be used.

In addition, an amount ratio of the mixed solution and the magnetic particles may be appropriately selected according to the concentration of the mixed solution, the thickness of the resin coating layer to be formed, and the like.

Furthermore, in the step A, other components to be contained in the resin coating layer, such as particles, may be added to the mixer in addition to the mixed solution and the magnetic particles.

Details of the mixed solution containing the resin and the solvent, the magnetic particles, and other components used in the step A will be described later.

### Step B

The manufacturing method of an electrostatic charge image developing carrier according to the present exemplary embodiment includes a step B in which the resin-coated magnetic particles after the step A are fluidized in a fluidized bed equipment in a state of being maintained at a temperature T_{B}.

Here, the temperature T_{B} is equal to or higher than the above-described glass transition temperature Tg−20° C. and equal to or lower than the above-described glass transition temperature Tg+50° C.

That is, in the step B, in a case where the resin-coated magnetic particles crushed in the step A are fluidized, the fluidizing is performed in a state in which a temperature of the resin-coated magnetic particles is maintained at a temperature T_{B} in a range of equal to or higher than Tg−20° C. and equal to or lower than Tg+50° C. based on the glass transition temperature Tg of the resin contained in the mixed solution (the resin contained in the resin coating layer).

For example, in a case where the glass transition temperature Tg of the resin is 110° C., the temperature T_{B} may be 90° C. or higher and 160° C. or lower.

In addition, in order to maintain the resin-coated magnetic particles at the temperature T_{B}, the temperature of the fluidizing gas in the fluidized bed equipment, the jacket temperature of the fluidized bed equipment, or both may be adjusted.

The temperature T_{B} is measured as follows.

That is, the temperature T_{B} is a gas temperature measured immediately after the resin-coated magnetic particles are fluidized by installing a thermometer in an upper part of the fluidization device or in an exhaust pipe part of the fluidizing gas.

In addition, the temperature T_{A} in the step A and the temperature T_{B} in the step B may be the same temperature or different temperatures as long as the temperatures are within the range of equal to or higher than the glass transition temperature Tg−20° C. and equal to or lower than the glass transition temperature Tg+50° C.

From the viewpoint of further enhancing the color haze suppression property of the image to be obtained, a difference between the temperature T_{A} in the step A and the temperature T_{B} in the step B is, for example, preferably 15° C. or lower and more preferably 10° C. or lower. This is because the effect of suppressing the color haze of the image can be obtained in a shorter time as the difference in temperature is smaller.

From the viewpoint of further enhancing the color haze suppression property of the image to be obtained, the temperature T_{B} is, for example, preferably equal to or higher than the glass transition temperature Tg-20° C. and equal to or lower than the glass transition temperature Tg+20° C., and more preferably equal to or higher than the glass transition temperature Tg-15° C. and equal to or lower than the glass transition temperature Tg° C. In the same manner as in the step A, in a case where the agitating work amount is too large at a temperature of equal to or higher than the glass transition temperature Tg by 50° C., the peeling of the resin coating layer formed on the surface of the magnetic particles easily occurs, so that, for example, the vicinity of Tg is preferable.

From the viewpoint of further enhancing the color haze suppression property of the image to be obtained, a fluidizing time of the resin-coated magnetic particles in a state of being maintained at the temperature T_{B} is correlated with the temperature in terms of the fixation of the resin coating layer. The time can be shorter as the temperature is higher, but for example, the time is preferably 20 minutes or longer, more preferably 30 minutes or longer, and still more preferably 45 minutes or longer.

In addition, since the amount of free resin in the resin coating layer may be increased due to contact between resin-coated magnetic particles by the fluidizing, the upper limit of the fluidizing time of the resin-coated magnetic particles in a state of being maintained at the temperature T_{B} is, for example, 360 minutes, preferably 120 minutes or shorter.

The fluidizing time of the resin-coated magnetic particles in a state of being maintained at the temperature T_{B} is, for example, preferably 20 minutes or longer and 120 minutes or shorter, more preferably 30 minutes or longer and 90 minutes or shorter, and still more preferably 45 minutes or longer and 60 minutes or shorter.

### Step C

The manufacturing method of an electrostatic charge image developing carrier according to the present exemplary embodiment includes a step C of cooling the resin-coated magnetic particles after the step B. For example, it is preferable that the step C is performed in the fluidized bed equipment following the step B.

Here, a cooling temperature of the resin-coated magnetic particles is, for example, preferably equal to or lower than the glass transition temperature Tg−30° C., and more preferably equal to or lower than the glass transition temperature Tg−40° C. Examples of the lower limit of the cooling temperature of the resin-coated magnetic particles include room temperature, for example, 20° C.

Here, the cooling temperature refers to a temperature at which the resin-coated magnetic particles reach by cooling in the fluidized bed equipment.

In the present exemplary embodiment, from the viewpoint of further enhancing the color haze suppression property of the image to be obtained, for example, it is preferable that, in the step B, the resin-coated magnetic particles after the step A are fluidized for 30 minutes or longer in the state of being maintained at the temperature T_{B}, and in the step C, the resin-coated magnetic particles are cooled to a temperature Tc of equal to or lower than the glass transition temperature Tg−40° C.

In addition, a cooling time of the resin-coated magnetic particles is not particularly limited, but from the viewpoint of manufacturing speed of the carrier and color haze suppression property of the image to be obtained, the cooling time is preferably 10 minutes or longer and 360 minutes or shorter, more preferably 30 minutes or longer and 240 minutes or shorter, and particularly preferably 60 minutes or longer and 150 minutes or shorter.

In the step B and the step C, the fluidized bed equipment is used. By allowing the resin-coated magnetic particles to flow and further cooling using a non-agitating type mixing fluidized bed equipment, the fixation of the resin coating layer to the magnetic particles can be promoted.

The fluidized bed equipment includes a fluidized bed equipment using only the flowing air or a vibration fluidized bed that assists in fluidization by vibration, but is not particularly limited.

The fluidized bed equipment may be a device that can jet a gas (also referred to as a fluidizing gas) in which the resin-coated magnetic particles are temperature-controlled and dehumidified to the above-described temperature T_{B} or Tc from the bottom of the device. That is, the fluidized bed equipment has a mechanism for heating or cooling the gas.

Examples of the mechanism for heating the gas include an air heater. For example, by supplying a gas heated to the temperature T_{B} to the bottom of the device by an air heater provided outside the body of the fluidized bed equipment, the resin-coated magnetic particles can be fluidized in a state of being maintained at the temperature T_{B}.

The mechanism for cooling the gas is not particularly limited. The resin-coated magnetic particles may be cooled (for example, to equal to or lower than the glass transition temperature Tg−40° C.) by supplying a gas at room temperature to the bottom of the device.

In addition, the gas may be heated or cooled by circulating hot water or cooling water through the body of the fluidized bed equipment as a jacket structure.

For example, it is preferable that the step B is continuously performed after the step A.

Specifically, for example, it is preferable that the resin-coated magnetic particles after the crushing in the step A are directly put into the fluidized bed equipment from the mixer.

The temperature of the resin-coated magnetic particles in the fluidized bed equipment can be adjusted by a conductive heat transfer efficiency that is determined by an agitating state in the vessel from the temperature of the resin-coated magnetic particles put into the device, the temperature of the fluidizing gas, and the superficial velocity of the fluidizing gas based on the minimum fluidization velocity Umf described later. For example, as the temperature of the fluidizing gas is higher and the superficial velocity is faster, the temperature of the resin-coated magnetic particles can be increased in a shorter time.

During the fluidizing of the resin-coated magnetic particles in the fluidized bed equipment in the state of being maintained at the temperature T_{B}, for example, it is preferable to reduce friction between the resin-coated magnetic particles and to reduce a shear force that the resin-coated magnetic particles receive from the gas. This is because, in a case where the temperature T_{B} is equal to or higher than the glass transition temperature Tg, the resin-coated magnetic particles are likely to be affected by stress such as the above-described friction and shear force, and the peeling of the resin coating layer is likely to occur.

In order to reduce the friction between the resin-coated magnetic particles or to reduce the shear force that the resin-coated magnetic particles receive from the gas, it is sufficient that a superficial velocity V_{H} (m/s) of the fluidizing gas in the fluidized bed equipment during the fluidizing of the resin-coated magnetic particles after the crushing in the state of being maintained at the temperature T_{B} is small.

Specifically, in the step B, the superficial velocity V_{H} (m/s) of the fluidizing gas in the fluidized bed equipment during the fluidizing of the resin-coated magnetic particles after the step A in the state of being maintained at the temperature T_{B} satisfies, for example, preferably 1 times or more and 5 times or less the minimum fluidization velocity Umf, and more preferably 2 times or more and 3 times or less the minimum fluidization velocity Umf.

The minimum fluidization velocity Umf can be obtained by the following expression from a flow rate at a change point at which the pressure of the fluidizing gas experimentally increases and then begins to stabilize.

Minimum fluidization velocity Umf (m/s)=Flow rate (m³/s) at the change point=Cross-sectional area (m²) of the fluidization device

In addition, the superficial velocity V_{H} of the fluidizing gas during the fluidizing of the resin-coated magnetic particles in the state of being maintained at the temperature T_{B} is not particularly limited, but preferably 10 mm/s or more and 50 mm/s or less, and more preferably 20 mm/s or more and 30 mm/s or less.

In addition, from the viewpoint of improving cooling efficiency, a superficial velocity V_{C} (m/s) of the fluidizing gas in the fluidized bed equipment during the cooling of the resin-coated magnetic particles is, for example, preferably 2 times or more and 10 times or less the minimum fluidization velocity Umf, and more preferably 5 times or more and 10 times or less the minimum fluidization velocity Umf.

In addition, from the viewpoint of improving the cooling efficiency, for example, it is preferable that the superficial velocity V_{C} (m/s) of the fluidizing gas in the fluidized bed equipment during the cooling of the resin-coated magnetic particles is larger than the superficial velocity V_{H} (m/s) of the fluidizing gas in the fluidized bed equipment during the fluidizing of the resin-coated magnetic particles in the state of being maintained at the temperature T_{B}.

The fluidizing gas in the fluidization device is not particularly limited, and air, nitrogen, argon, or the like can be used. Among the above, for example, air is preferable.

In addition, the fluidizing gas is, for example, preferably a dehumidified gas, preferably a gas having a relative humidity of 30% or less, more preferably a gas having a relative humidity of 20% or less, and particularly preferably a gas having a relative humidity of 10% or less.

By passing through the step A, the step B, and the step C described above, an electrostatic charge image developing carrier, in which the resin coating layer is formed on the surface of the magnetic particles, is obtained.

### Other Steps

The manufacturing method of an electrostatic charge image developing carrier according to the present exemplary embodiment may include a step other than the step A, the step B, and the step C.

Other steps are not particularly limited, and may include known steps in the manufacturing method of an electrostatic charge image developing carrier.

The manufacturing method of an electrostatic charge image developing carrier according to the present exemplary embodiment further includes, for example, preferably a step of preparing the magnetic particles, and a step of preparing the mixed solution containing the resin and the solvent.

### Physical Properties of Carrier

A volume-average particle size of the electrostatic charge image developing carrier obtained by the manufacturing method of an electrostatic charge image developing carrier according to the present exemplary embodiment is, for example, preferably 10 μm or more and 500 μm or less, more preferably 15 μm or more and 100 μm or less, and particularly preferably 20 μm or more and 60 μm or less.

Volume-average particle sizes of the magnetic particles and the carrier in the present exemplary embodiment are values measured by a laser diffraction type particle size distribution analyzer LA-700 (manufactured by HORIBA, Ltd.). Specifically, for the particle size range (channel) divided using a particle size distribution obtained by the measurement device, a cumulative distribution is plotted from the small-sized particles, and the particle size at which the cumulative percentage of the particles reaches 50% is adopted as the volume-average particle size.

From the viewpoint of thickness stability of the resin coating layer and charging properties, an amount of the resin coating layer in the electrostatic charge image developing carrier obtained by the manufacturing method of an electrostatic charge image developing carrier according to the present exemplary embodiment is, for example, preferably 0.5% by mass or more and 10% by mass or less, and more preferably 1% by mass or more and 5% by mass or less with respect to the total mass of the carrier.

From the viewpoint of color haze suppression property of the image to be obtained, an amount of free resin in the electrostatic charge image developing carrier obtained by the manufacturing method of an electrostatic charge image developing carrier according to the present exemplary embodiment is, for example, preferably 300 ppm or less, more preferably 100 ppm or less, still more preferably 50 ppm or less, and particularly preferably 30 ppm or less.

A method of measuring the amount of free resin in the electrostatic charge image developing carrier in the present exemplary embodiment is as follows.

The carrier is weighed in a specific amount and dispersed in water, and the dispersion is filtered while fixing the carrier with a magnet. The filter paper is dried, and the amount of free resin is calculated by the following expression from a difference in mass of the filter paper before and after the drying and the amount of carrier weighed.

$$Amount of free resin ( ppm ) = Filter paper increase amount ( g ) \div Carrier ( g )$$

In the electrostatic charge image developing carrier obtained by the manufacturing method of an electrostatic charge image developing carrier according to the present exemplary embodiment, a proportion of aggregates after classification with a sieve of 75 μm is better to be smaller, and from the viewpoint of color haze suppression property of the image to be obtained, the proportion is, for example, preferably 5% by number or less, more preferably 1% by number or less, still more preferably 0.1% by number or less, and particularly preferably 0.01% by number or less.

A method of measuring the proportion of aggregates after the classification with a sieve of 75 μm in the electrostatic charge image developing carrier in the present exemplary embodiment is as follows.

The carrier is sieved with a sieve having an opening size of 75 μm, the sieved carriers are spread so as not to overlap as much as possible, and a scanning electron microscope (SEM) photograph at a magnification of 350 times is taken, and a proportion of the number of carriers not crushed into primary particles to the number of carriers in one field of view is measured.

An exposed area ratio of the magnetic particles in the electrostatic charge image developing carrier in the present exemplary embodiment is, for example, preferably 3% or more and 30% or less, more preferably 4% or more and 25% or less, and still more preferably 5% or more and 20% or less. The exposed area ratio of the magnetic particles in the carrier can be controlled by the amount of the resin used for forming the resin coating layer, and as the amount of the resin relative to the amount of the magnetic particles is larger, the exposed area ratio is smaller.

That is, a coverage of the resin coating layer on the surface of the electrostatic charge image developing carrier in the present exemplary embodiment is, for example, preferably 70% or more and 97% or less, more preferably 75% or more and 96% or less, and still more preferably 80% or more and 95% or less.

The exposed area ratio of the magnetic particles and the coverage of the resin coating layer on the surface of the carrier are values obtained by the following method.

A target carrier and magnetic particles obtained by removing the resin coating layer from the target carrier are prepared. Examples of a method of removing the resin coating layer from the carrier include a method of removing the resin coating layer by dissolving resin components with an organic solvent, and a method of removing the resin coating layer by heating the carrier to approximately 800° C. to eliminate the resin components. Using each of the carrier and the magnetic particles as measurement samples, a ratio of FE, C, and O (atomic %) on the sample surface is quantified by XPS, and (Fe ratio of carrier)=(Fe ratio of magnetic particles)×100 is calculated as the exposed area ratio (%) of the magnetic particles.

In addition, the coverage (%) of the resin coating layer is obtained from (100-Exposed area ratio of magnetic particles).

From the viewpoint of density change suppression property in the obtained image, a fluidity of the electrostatic charge image developing carrier in the present exemplary embodiment is, for example, preferably 20 seconds/50 g or more and 50 seconds/50 g or less, more preferably 22 seconds/50 g or more and 35 seconds/50 g or less, and particularly preferably 25 seconds/50 g or more and 30 seconds/50 g or less.

The fluidity of the electrostatic charge image developing carrier in the present exemplary embodiment is a value measured at 25° C. and 50% RH according to JIS Z 2502 (2020).

### Configuration of Carrier

The electrostatic charge image developing carrier obtained by the manufacturing method of an electrostatic charge image developing carrier according to the present exemplary embodiment has a resin coating layer on the surface of the magnetic particles.

Hereinafter, the configuration of the electrostatic charge image developing carrier in the present exemplary embodiment will be described.

### Magnetic Particles

As the magnetic particles used in the present exemplary embodiment, known magnetic particles are used.

As the above-described magnetic particles, a known material is used. Examples thereof include magnetic metals such as iron, nickel, and cobalt; alloys of these magnetic metals with manganese, chromium, rare earth elements, and the like; magnetic oxides such as iron oxide, ferrite, and magnetite; and resin dispersion-type magnetic particles in which a conductive material or the like is dispersed in a matrix resin.

Examples of a resin used in the above-described resin dispersion-type magnetic particles include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured with an organosiloxane bond, a product obtained by modifying the straight silicone resin, a fluororesin, polyester, polycarbonate, a phenol resin, and an epoxy resin, but the resin is not limited thereto.

Among the above, as the magnetic particles, for example, magnetic oxide particles are preferable, and ferrite particles are more preferable.

### Ferrite Particles

The ferrite is generally represented by (MO)_{X}(Fe₂O₃)_{Y}. In the formula, M is generally Mn, but may be a combination of at least one or a plurality of kinds selected from the group consisting of Li, Ca, Sr, Sn, Cu, Zn, Ba, Fe, Ti, Ni, Al, Co, and Mo. In addition, X and Y represent a molar ratio, and satisfy a requirement of X+Y=100. In general, characteristics of the ferrite particles vary depending on the composition and the structure thereof.

The ferrite particles used in the present exemplary embodiment are not particularly limited, and can be produced, for example, as follows.

Powders of the metal oxide or the metal salt serving as a raw material are mixed with each other, and the mixture is subjected to temporary firing using a rotary kiln or the like to obtain a temporary fired product. Here, examples of the metal oxide or the metal salt serving as a raw material include Fe₂O₃, MnO₂, SrCO₃, and Mg (OH)₂, and a content of strontium in the ferrite particles is set to 0.1% by mass or more and 1.0% by mass or less by adjusting the amount of SrCO₃, for example. In addition, examples of a temperature of the temporary firing include 800° C. or higher and 1,000° C. or lower, and examples of a time of the temporary firing include 6 hours or longer and 10 hours or shorter. The obtained temporary fired product is pulverized by a known pulverization method, specifically, by adding polyvinyl alcohol and water, a surfactant, and an antifoaming agent thereto, and pulverizing the mixture by a mortar, a ball mill, a jet mill, or the like. The pulverization of the temporary fired product is performed, for example, until the average particle size is 4 μm or more and 10 μm or less. Next, the pulverized temporary fired product is granulated with a spray dryer, and dried. The dried temporary fired product is temporary fired (re-temporary fired) again to remove the contained organic substance and obtain a re-temporary fired product. Examples of a temperature of the re-temporary firing include 800° C. or higher and 1,000° C. or lower, and examples of a time of the re-temporary firing include 5 hours or longer and 10 hours or shorter. The obtained re-temporary fired product is pulverized by adding polyvinyl alcohol and water, a surfactant, and an antifoaming agent thereto, and pulverizing the mixture by a mortar, a ball mill, a jet mill, or the like. The pulverization of the re-temporary fired product is performed, for example, until the average particle size is 4 μm or more and 8 μm or less. Next, the pulverized re-temporary fired product is granulated with a spray dryer, and dried. The granulated product after the drying is fired (main-fired) using a rotary kiln or the like to obtain a main fired product. Here, examples of a temperature of the main firing include 1,000° C. or higher and 1,400° C. or lower, and examples of a time of the main firing include 3 hours or longer and 6 hours or shorter. Subsequently, the ferrite particles are obtained through a crushing step and a classifying step of the main fired product.

A volume-average particle size of the magnetic particles used in the present exemplary embodiment is, for example, preferably 10 μm or more and 500 μm or less, more preferably 15 μm or more and 100 μm or less, and particularly preferably 20 μm or more and 60 μm or less.

The average particle size of the fired product or the ferrite particles refers to a value measured using a laser diffraction/scattering-type particle size distribution analyzer (LS Particle Size Analyzer; LS13 320, manufactured by Beckman Coulter, Inc.). For the particle size range (channel) divided using the obtained particle size distribution, a cumulative distribution is plotted from the small-sized particles, and a particle size at which the cumulative percentage reaches 50% is adopted as the volume-average particle size of 50%.

From the viewpoint of long-term image quality stability and density change suppression property, a value of a BET specific surface area of the magnetic particles is, for example, preferably 0.10 m²/g or more and 0.35 m²/g or less, more preferably 0.11 m²/g or more and 0.28 m²/g or less, and particularly preferably 0.12 m²/g or more and 0.24 m²/g or less. In addition, within the above-described range, an appropriate amount of the coating resin enters the gap of the magnetic particles, deterioration of the resin coating layer due to anchoring effect can be suppressed, and the long-term image quality stability and the density change suppression property are excellent.

The BET specific surface area of the magnetic particles is measured by a three-point nitrogen substitution method using a SA3100 specific surface area measurement device (manufactured by Beckman Coulter, Inc.). Specifically, 5 g of the magnetic particles are put into a cell, deaeration treatment is performed at 60° C. for 120 minutes, and the three-point nitrogen substitution method is performed using a mixed gas of nitrogen and helium (30:70).

As the method of separating the magnetic particles from the carrier, more specifically, for example, 20 g of a resin-coated carrier is put into 100 mL of toluene. An ultrasonic wave is applied thereto for 30 seconds under the condition of 40 kHz. The magnetic particles and the resin solution are separated by using an arbitrary filter paper according to the particle size. The magnetic particles remaining on the filter paper are washed by pouring 20 mL of toluene from above. Next, the magnetic particles remaining on the filter paper are collected. Similarly, the collected magnetic particles are put into 100 mL of toluene, and an ultrasonic wave is applied thereto for 30 seconds under the condition of 40 kHz. The magnetic particles are filtered in the same manner, washed with 20 mL of toluene, and then collected. This process is performed 10 times. The finally collected magnetic particles are dried, and the BET specific surface area is measured under the above conditions.

An arithmetic mean height Ra (JIS B 0601:2001) of a roughness curve of the magnetic particles is, for example, preferably 0.1 μm or more and 1 μm or less, and more preferably 0.2 μm or more and 0.8 μm or less.

The arithmetic mean height Ra of the roughness curve of the magnetic particles is obtained by observing the magnetic particles at an appropriate magnification (for example, 1000 times) using a surface shape measuring device (for example, “Ultra-deep color 3D shape measuring microscope VK-9700” manufactured by Keyence Corporation) to obtain the roughness curve with a cutoff value of 0.08 mm, and extracting a reference length of 10 μm in a direction of the average line from the roughness curve. Ra's of 100 magnetic particles are arithmetically averaged.

As for a magnetic force of the magnetic particles, a saturation magnetization of the magnetic particles in a magnetic field of 3,000 Oe is, for example, preferably 50 emu/g or more, and more preferably 60 emu/g or more. The saturation magnetization is measured using a vibrating sample magnetometer VSMP10-15 (manufactured by TOEI INDUSTRY CO., LTD.). The measurement sample is packed in a cell having an inner diameter of 7 mm and a height of 5 mm and set in the aforementioned magnetometer. For the measurement, a magnetic field is applied and swept up to 3,000 Oe. Next, the applied magnetic field is reduced, and a hysteresis curve is created on recording paper. Saturation magnetization, residual magnetization, and coercive force are obtained from the data of the curve.

An electrical volume resistance (volume resistivity) of the magnetic particles is, for example, preferably 1 ×10⁵ Ω·cm or more and 1×10⁹ Ω·cm or less, and more preferably 1 ×10⁷ Ω·cm or more and 1 ×10⁹ Ω·cm or less.

The electrical volume resistance (Ω·cm) of the magnetic particles is measured as follows. A measurement target is placed flat on the surface of a circular jig on which a 20 cm² electrode plate is disposed, such that the measurement target has a thickness of approximately 1 mm or more and 3 mm or less and forms a layer. The above-described 20 cm² electrode plate is placed on the layer such that the layer is sandwiched between the electrode plates. In order to eliminate voids between measurement targets, a load of 4 kg is applied onto the electrode plates arranged on the layer, and then the thickness (cm) of the layer is measured. Both the upper and lower electrodes of the layer are connected to an electrometer and a high-voltage power supply device. A high voltage is applied to both electrodes such that an electric field of 103.8 V/cm is generated, and the current value (A) flowing at this time is read. The volume resistivity is measured in an environment at a temperature of 20° C. and a relative humidity of 50%. An expression for calculating the electrical volume resistance (22 cm) of the measurement target is as follows.

$$R = E \times 20 / ( I - {I}_{0} ) / L$$

In the above expression, R represents an electrical volume resistance (Ω·cm) of the measurement target, E represents an applied voltage (V), I represents a current value (A), I₀ represents a current value (A) at an applied voltage of 0 V, and L represents a thickness of the layer (cm). The coefficient of 20 represents an area (cm²) of the electrode plate.

### Resin Coating Layer

The electrostatic charge image developing carrier in the present exemplary embodiment has a resin coating layer that coats the magnetic particles.

Examples of the resin configuring the resin coating layer include a styrene acrylic acid copolymer; a polyolefin-based resin such as polyethylene or polypropylene; a polyvinyl-based or polyvinylidene-based resins such as polystyrene, an acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

Among the resins, as the resin configuring the resin coating layer, from the viewpoint of charging properties, external additive adhesion controllability, and density change suppression property, for example, it is preferable to contain an acrylic resin, it is more preferable to contain an acrylic resin in an amount of 50% by mass or more with respect to the total mass of resins in the resin coating layer, and it is particularly preferable to contain an acrylic resin in an amount of 80% by mass or more with respect to the total mass of resins in the resin coating layer.

From the viewpoint of density change suppression property, for example, the resin coating layer preferably contains an acrylic resin having an alicyclic structure. As a polymerization component of the acrylic resin having an alicyclic structure, for example, a lower alkyl ester of (meth)acrylic acid (for example, a (meth)acrylic acid alkyl ester having an alkyl group having 1 or more and 9 or less carbon atoms) is preferable, and specific examples thereof include methyl (meth)acrylate, ethyl (meth)acrylate, propyl (meth)acrylate, butyl (meth)acrylate, hexyl (meth)acrylate, cyclohexyl (meth)acrylate, and 2-ethylhexyl (meth)acrylate. The monomers may be used alone or in combination of two or more.

For example, the acrylic resin having an alicyclic structure preferably includes, as the polymerization component, cyclohexyl (meth)acrylate. With respect to the total mass of the acrylic resin having an alicyclic structure, a content of a monomer unit derived from the cyclohexyl (meth)acrylate included in the acrylic resin having an alicyclic structure is, for example, preferably 75% by mass or more and 100% by mass or less, more preferably 85% by mass or more and 100% by mass or less, and even more preferably 95% by mass or more and 100% by mass or less.

A weight-average molecular weight of the resin contained in the resin coating layer is, for example, preferably less than 300,000, more preferably less than 250,000, even more preferably 5,000 or more and less than 250,000, and particularly preferably 10,000 or more and 200,000 or less. Within the above-described range, smoothness of the resin-coated surface of the carrier is improved, so that the amount of the external additive adhering to the carrier is reduced, and the density change suppression property is more excellent.

For the purpose of controlling charging and resistance, the resin coating layer may contain conductive particles. Examples of the conductive particles include carbon black and particles having conductivity among inorganic particles described later. Among the above, for example, carbon black is preferable.

From the viewpoint of charging properties, a content of the conductive particles contained in the resin coating layer is, for example, preferably 0.1% by mass or more and 30% by mass or less, more preferably 0.5% by mass or more and 20% by mass or less, and still more preferably 1% by mass or more and 10% by mass or less with respect to the total mass of the resin coating layer.

In addition, the resin coating layer may contain inorganic particles.

Examples of the inorganic particles contained in the resin coating layer include metal oxide particles such as silica, titanium oxide, zinc oxide, and tin oxide; metal compound particles such as barium sulfate, aluminum borate, and potassium titanate; and metal particles such as gold, silver, and copper.

Among the above, from the viewpoint of density change suppression property, for example, silica particles are preferable.

From the viewpoint of density change suppression property, an arithmetic average particle size of the inorganic particles in the resin coating layer is, for example, preferably 5 nm or more and 90 nm or less, more preferably 5 nm or more and 70 nm or less, still more preferably 5 nm or more and 50 nm or less, and particularly preferably 8 nm or more and 50 nm or less.

In the present exemplary embodiment, the average particle size of the inorganic particles contained in the resin coating layer is obtained by the following method.

The carrier is embedded in an epoxy resin, and cut with a microtome to produce a carrier cross section. An SEM image obtained by imaging the carrier cross section with a scanning electron microscope (SEM) is incorporated into an image processing analysis apparatus, and image analysis is performed. 100 inorganic particles (primary particles) in the resin coating layer are randomly selected, the equivalent circle diameter (nm) of each particle is obtained, and an arithmetic mean of the equivalent circle diameters is defined as the average particle size (nm) of the inorganic particles.

The surface of the inorganic particles may be subjected to a hydrophobic treatment. Examples of a hydrophobic agent include known organosilicon compounds having an alkyl group (for example, a methyl group, an ethyl group, a propyl group, a butyl group, and the like), and specific examples thereof include an alkoxysilane compound, a siloxane compound, and a silazane compound. Among the above, as the hydrophobic agent, for example, a silazane compound is preferable, and hexamethyldisilazane is preferable. One kind of hydrophobic agent may be used alone, or two or more kinds of hydrophobic agents may be used in combination.

Examples of a method for subjecting the inorganic particles to the hydrophobic treatment with the hydrophobic agent include a method of, using supercritical carbon dioxide, dissolving the hydrophobic agent in the supercritical carbon dioxide to adhere the hydrophobic agent to the surface of the inorganic particles; a method of applying (for example, spraying or coating) a solution containing the hydrophobic agent and a solvent that dissolves the hydrophobic agent onto the surface of the inorganic particles to adhere the hydrophobic agent to the surface of the inorganic particles in the atmosphere; and a method of adding a solution containing the hydrophobic agent and a solvent that dissolves the hydrophobic agent to the inorganic particle dispersion to be held, and then drying a mixed solution of the inorganic particle dispersion and the solution in the atmosphere.

From the viewpoint of density change suppression property, a content of the inorganic particles contained in the resin coating layer is, for example, preferably 10% by mass or more and 60% by mass or less, more preferably 15% by mass or more and 55% by mass or less, and still more preferably 20% by mass or more and 50% by mass or less with respect to the total mass of the resin coating layer.

The solvent used for forming the resin coating layer is not particularly limited as long as the solvent dissolves or disperses the resin, and for example, aromatic hydrocarbons such as toluene and xylene; ketones such as acetone and methyl ethyl ketone; ethers such as tetrahydrofuran and dioxane; and the like are used.

Among the above, for example, toluene is preferable.

In addition, an amount of solid content of the mixed solution used for forming the resin coating layer is not particularly limited, but preferably 5% by mass or more and 50% by mass or less, and more preferably 10% by mass or more and 30% by mass or less.

Furthermore, the mixed solution may contain conductive particles, inorganic particles, or the like, and in the step A, the conductive particles, inorganic particles, or the like may be added separately from the mixed solution.

An average thickness of the resin coating layer is, for example, preferably 0.1 μm or more and 10 μm or less, more preferably 0.2 μm or more and 5 μm or less, and still more preferably 0.3 μm or more and 3 μm or less.

The average thickness of the resin coating layer is measured by the following method. The carrier is embedded in an epoxy resin or the like and cut with a diamond knife or the like to produce a thin slice. The thin slice is observed with a transmission electron microscope (TEM) or the like, and cross-sectional images of a plurality of carrier particles are imaged. The thicknesses of the resin coating layer are measured at 20 locations in the cross-sectional images of the carrier particles, and the average thereof is adopted.

### Manufacturing Method of Electrostatic Charge Image Developer

The manufacturing method of an electrostatic charge image developer according to the present exemplary embodiment includes the manufacturing method of an electrostatic charge image developing carrier according to the present exemplary embodiment.

Specifically, the manufacturing method of an electrostatic charge image developer according to the present exemplary embodiment includes the manufacturing method of an electrostatic charge image developing carrier according to the present exemplary embodiment and a step of mixing the electrostatic charge image developing carrier manufactured by the manufacturing method of an electrostatic charge image developing carrier according to the present exemplary embodiment with a toner.

The electrostatic charge image developer manufactured by the manufacturing method of an electrostatic charge image developer according to the present exemplary embodiment is a two-component developer that contains the electrostatic charge image developing carrier manufactured by the manufacturing method of an electrostatic charge image developing carrier according to the present exemplary embodiment and the toner.

A mixing ratio (mass ratio) between the carrier and the toner in the developer, represented by carrier: toner, is, for example, preferably 100:1 to 100:30, and more preferably 100:3 to 100:20.

### Toner

The toner contains toner particles, and an external additive as necessary.

The toner particles include, for example, a binder resin and, as necessary, a colorant, a release agent, and other additives.

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable.

Examples of the polyester resin include known amorphous polyester resins. As the polyester resin, a crystalline polyester resin may be used in combination with an amorphous polyester resin. However, a content of the crystalline polyester resin may be, for example, in a range of 2% by mass or more and 40% by mass or less (for example, preferably 2% by mass or more and 20% by mass or less) with respect to all binder resins.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (° C./min) is within 10° C.

On the other hand, the “amorphous” resin indicates that the half-width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the above, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having a valency of 3 or more and a crosslinked structure or a branched structure may be used in combination with a diol. Examples of the polyhydric alcohol having a valency of 3 or more include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121:1987, “Testing methods for transition temperatures of plastics”.

A weight-average molecular weight (Mw) of the amorphous polyester resin is, for example, preferably 5,000 or more and 1,000,000 or less, and more preferably 7,000 or more and 500,000 or less.

A number-average molecular weight (Mn) of the amorphous polyester resin is, for example, preferably 2,000 or more and 100,000 or less.

A molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC. HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the copolymerization reaction, for example, the monomer with poor compatibility may be condensed in advance with an acid or an alcohol that is to be polycondensed with the monomer, and then polycondensed with the major component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate formed of a linear aliphatic polymerizable monomer than a polycondensate formed of a polymerizable monomer having an aromatic ring.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

A melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121: 1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a known manufacturing method, for example, same as the amorphous polyester resin.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

### Colorant

Examples of the colorant include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

A content of the colorant is, for example, preferably 1% by mass or more and 30% by mass or less and more preferably 3% by mass or more and 15% by mass or less with respect to the total amount of the toner particles.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K7121: 1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include known additives such as a magnetic material, an antistatic agent, and inorganic powder. The additives are incorporated into the toner particles as internal additives.

### Characteristics and the Like of Toner Particles

The toner particles may be toner particles that have a single-layer structure or toner particles having a so-called core/shell structure that is configured with a core portion (core particle) and a coating layer (shell layer) coating the core portion.

The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The volume-average particle size (D50v) of the toner particles is measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000. A volume-based particle size distribution is drawn from the small size side, and a particle size at which the cumulative percentage is 50% is defined as the volume-average particle size D50v.

The average circularity of the toner particles is, for example, preferably 0.94 or more and 1.00 or less, and more preferably 0.95 or more and 0.98 or less.

The average circularity of the toner particles is determined by (equivalent circular perimeter length)/(perimeter length) [(perimeter length of circle having the same projected area as particle image)/(perimeter length of particle projection image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains external additives, the toner (developer) as a measurement target is dispersed in water containing a surfactant, then the dispersion is treated with ultrasonic waves such that the external additives are removed, and the toner particles are obtained.

### Manufacturing Method of Toner Particles

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

Specifically, in a case where the toner particles are manufactured by the aggregation and coalescence method, for example, the toner particles are manufactured through a step of preparing a resin particle dispersion in which resin particles to be the binder resin are dispersed (a resin particle dispersion-preparing step), a step of allowing the resin particles (and other particles as necessary) to be aggregated in the resin particle dispersion (in the dispersion after mixing other particle dispersions as necessary) so as to form aggregated particles (aggregated particle-forming step), and a step of heating an aggregated particle dispersion in which the aggregated particles are dispersed to allow the aggregated particles to undergo coalescence and to form toner particles (coalescence step).

Hereinafter, each of the steps will be specifically described.

In the following section, a method for obtaining toner particles containing a colorant and a release agent will be described. The colorant and the release agent are used as necessary. Naturally, other additives different from the colorant and the release agent may also be used.

### Resin Particle Dispersion-Preparing Step

For example, a colorant particle dispersion in which colorant particles are dispersed and a release agent particle dispersion in which release agent particles are dispersed are prepared together with the resin particle dispersion in which resin particles to be a binder resin are dispersed.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having a medium, a sand mill, and a dyno mill. Depending on the type of resin particles, the resin particles may be dispersed in the dispersion medium by using a transitional phase-transfer emulsification method. The transitional phase-transfer emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes phase transition from W/O to O/W and is dispersed in the aqueous medium in a particulate form.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less.

For determining the volume-average particle size of the resin particles, a particle size distribution is measured using a laser diffraction-type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as that adopted for preparing the resin particle dispersion. That is, the volume-average particle size of the particles, the dispersion medium, the dispersion method, and the content of the particles in the resin particle dispersion are also applied to the colorant particles to be dispersed in the colorant particle dispersion and the release agent particles to be dispersed in the release agent particle dispersion.

### Aggregated Particle-Forming Step

Next, the resin particle dispersion is mixed with the colorant particle dispersion and the release agent particle dispersion.

Thereafter, in the mixed dispersion, the resin particles, the colorant particles, and the release agent particles are hetero-aggregated such that aggregated particles are formed which have a diameter close to the diameter of the target toner particles and include the resin particles, the colorant particles, and the release agent particles.

Specifically, for example, an aggregating agent is added to the mixed dispersion, the pH of the mixed dispersion is adjusted such that the dispersion is acidic (for example, pH of 2 or higher and 5 or lower), and a dispersion stabilizer is added thereto as necessary. Thereafter, the dispersion is heated to a temperature of the glass transition temperature of the resin particles (specifically, for example, to a temperature equal to or higher than the glass transition temperature of the resin particles—30° C. and equal to or lower than the glass transition temperature of the resin particles—10° C.) such that the particles dispersed in the mixed dispersion are aggregated, thereby forming aggregated particles.

In the aggregated particle-forming step, for example, in a state where the mixed dispersion is agitated with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant contained in the mixed dispersion, an inorganic metal salt, and a metal complex having a valency of 2 or more. In a case where a metal complex is used as the aggregating agent, the amount of the surfactant used is reduced, and the charging characteristics are improved.

In addition to the aggregating agent, an additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

An amount of the chelating agent added with respect to 100 parts by mass of the resin particles is, for example, preferably 0.01 parts by mass or more and 5.0 parts by mass or less, and more preferably 0.1 parts by mass or more and less than 3.0 parts by mass.

### Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) such that the aggregated particles coalesce, thereby forming toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed to cause the resin particles to be aggregated and adhere to the surface of the aggregated particles and to form second aggregated particles, and a step of heating a second aggregated particle dispersion in which the second aggregated particles are dispersed to cause the second aggregated particles to coalesce and to form toner particles having a core/shell structure.

After the coalescence step ends, the toner particles formed in a solution are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze drying, flush drying, fluidized drying, vibratory fluidized drying, or the like may be performed.

For example, by adding an external additive to the obtained dry toner particles and mixing the external additive and the toner particles together, the toner used in the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂. K₂O. (TiO₂) N, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethyl methacrylate, and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 5% by mass or less, and more preferably 0.01% by mass or more and 2.0% by mass or less.

### Image Forming Apparatus and Image Forming Method

The above-described electrostatic charge image developer, that is, the electrostatic charge image developer containing the electrostatic charge image developing carrier manufactured by the manufacturing method of an electrostatic charge image developing carrier according to the present exemplary embodiment is applied to an image forming apparatus and an image forming method as follows.

The image forming apparatus used in the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image using the electrostatic charge image developer, a transfer unit that transfers the toner image formed on the surface of the image holder to the surface of a recording medium, and a fixing unit that fixes the toner image transferred to the surface of the recording medium.

In the image forming apparatus used in the present exemplary embodiment, an image forming method is performed with a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus used in the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge erasing unit that erases charge by irradiating the surface of the image holder with charge erasing light before charging after the transfer of the toner image.

In the case where the image forming apparatus used in the present exemplary embodiment is the intermediate transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus used in the present exemplary embodiment, for example, a portion including the developing unit may be a cartridge structure (process cartridge) detachable from the image forming apparatus. As the process cartridge, for example, a process cartridge is suitably used, including a developing unit that contains the electrostatic charge image developer containing the electrostatic charge image developing carrier manufactured by the manufacturing method of an electrostatic charge image developing carrier according to the present exemplary embodiment.

An example of the image forming apparatus used in the present exemplary embodiment will be shown below, but the present invention is not limited thereto. Hereinafter, among the parts shown in the drawings, main parts will be described, and others will not be described.

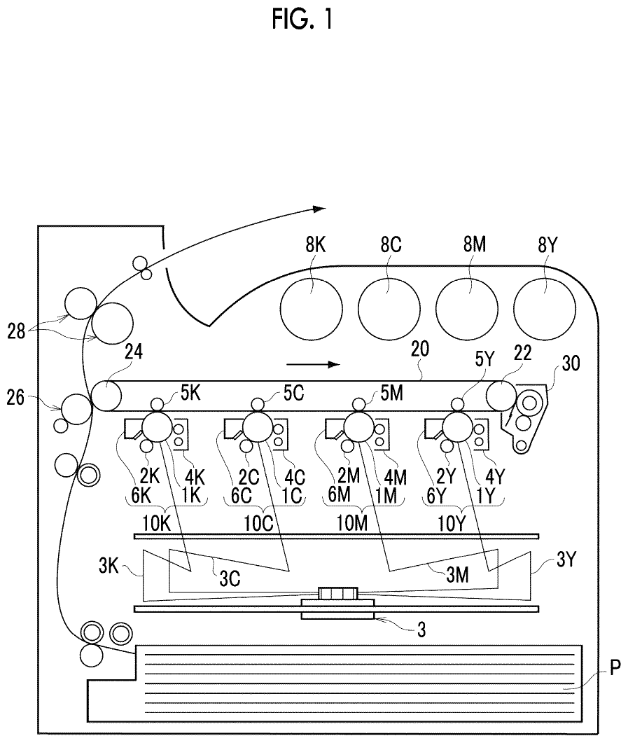

FIG. 1 is a view schematically showing the configuration of the image forming apparatus used in the present exemplary embodiment.

The image forming apparatus shown in FIG. 1 includes first to fourth image forming units 10Y, 10M, 10C, and 10K (image forming unit) adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are detachable from the image forming apparatus.

An intermediate transfer belt (an example of the intermediate transfer member) 20 passing through above the units 10Y, 10M, 10C, and 10K extends under the units. The intermediate transfer belt 20 is looped around a driving roll 22 and a support roll 24, and runs toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the image holding surface side of the intermediate transfer belt 20.

Yellow, magenta, cyan, and black toners contained in containers of toner cartridges 8Y, 8M, 8C, and 8K are supplied to developing devices (developing units) 4Y, 4M, 4C, and 4K of the units 10Y, 10M, 10C, and 10K, respectively.

The first to fourth units 10Y, 10M, 10C, and 10K have the same configuration and operation. Therefore, in the present specification, as a representative, the first unit 10Y will be described which is placed on the upstream side of the running direction of the intermediate transfer belt and forms a yellow image.

The first unit 10Y has a photoreceptor 1Y that acts as an image holder. Around the photoreceptor 1Y, a charging roll (an example of the charging unit) 2Y that charges the surface of the photoreceptor 1Y at a predetermined potential, an exposure device (an example of the electrostatic charge image forming unit) 3 that exposes the charged surface to a laser beam 3Y based on color-separated image signals to form an electrostatic charge image, a developing device (an example of the developing unit) 4Y that develops the electrostatic charge image by supplying a charged toner to the electrostatic charge image, a primary transfer roll 5Y (an example of the primary transfer unit) that transfers the developed toner image onto the intermediate transfer belt 20, and a photoreceptor cleaning device (an example of the cleaning unit) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. A bias power supply (not shown in the drawing) for applying a primary transfer bias is connected to primary transfer rolls 5Y, 5M, 5C, and 5K of each unit. Each bias power supply changes a value of the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of-600 V to-800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam, the specific resistance of the portion irradiated with the laser beam changes. From the exposure device 3, the laser beam 3Y is radiated to the surface of the charged photoreceptor 1Y according to the image data for yellow transmitted from the control unit not shown in the drawing. As a result, an electrostatic charge image of the yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y is developed as a toner image by the developing device 4Y and visualized.

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the erased latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. In the first unit 10Y, the transfer bias is set, for example, to +10 μA under the control of the control unit (not shown in the drawing).

On the other hand, the residual toner on the photoreceptor 1Y is removed by a photoreceptor cleaning device 6Y and collected.

The primary transfer bias applied to the primary transfer rolls 5M, 5C, and 5K following the second unit 10M is also controlled according to the first unit.

In this manner, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt 20, and a secondary transfer roll 26 (an example of a secondary transfer unit) disposed on the image holding surface side of the intermediate transfer belt 20. On the other hand, via a supply mechanism, recording paper P (an example of recording medium) is fed at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

The electrostatic charge image developer containing the electrostatic charge image developing carrier manufactured by the manufacturing method of an electrostatic charge image developing carrier according to the present exemplary embodiment may be applied to the process cartridge.

The process cartridge used in the present exemplary embodiment includes a developing unit that contains the electrostatic charge image developer containing the electrostatic charge image developing carrier manufactured by the manufacturing method of an electrostatic charge image developing carrier according to the present exemplary embodiment and develops an electrostatic charge image formed on the surface of an image holder as a toner image by using the electrostatic charge image developer. The process cartridge is detachable from the image forming apparatus.

The process cartridge used in the present exemplary embodiment is not limited to the above configuration. The process cartridge may be configured with a developing unit and, for example, at least one member selected from other units, such as an image holder, a charging unit, an electrostatic charge image forming unit, and a transfer unit, as necessary.

An example of the process cartridge used in the present exemplary embodiment will be shown below, but the present invention is not limited thereto. Hereinafter, among the parts shown in the drawings, main parts will be described, and others will not be described.

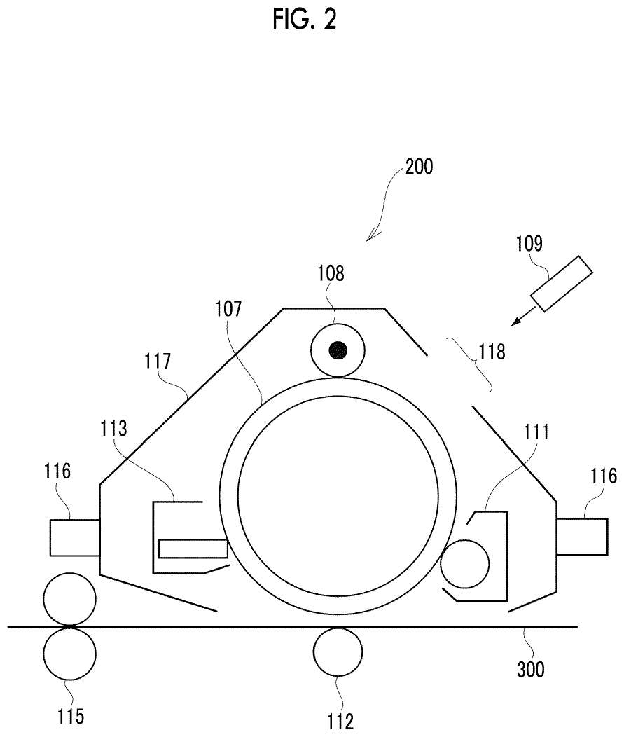

FIG. 2 is a view schematically showing the configuration of the process cartridge used in the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), that are integrally combined and held in the housing 117. The process cartridge 200 forms a cartridge in this way.

In FIG. 2, 109 indicates an exposure device (an example of electrostatic charge image forming unit), 112 indicates a transfer device (an example of transfer unit), 115 indicates a fixing device (an example of fixing unit), and 300 indicates recording paper (an example of recording medium).

### EXAMPLES

Hereinafter, exemplary embodiments of the invention will be specifically described based on examples. However, the exemplary embodiments of the invention are not limited to the examples. In the following description, unless otherwise specified, “parts” and “%” are based on mass.

### Production of Toner

### Production of Amorphous Polyester Resin Dispersion (A1)

Ethylene glycol: 37 parts
Neopentyl glycol: 65 parts
1,9-Nonanediol: 32 parts
Terephthalic acid: 96 parts

The above-described materials are put in a flask, the temperature is raised to 200° C. for 1 hour, and after it is confirmed that the inside of the reaction system is uniformly agitated, 1.2 parts of dibutyltin oxide is added. The temperature is raised to 240° C. for 6 hours in a state where the generated water is distilled off, and agitating is continued at 240° C. for 4 hours, thereby obtaining an amorphous polyester resin (acid value 9.4 mgKOH/g, weight-average molecular weight 13,000, glass transition temperature 62° C.). Molten amorphous polyester resin is transferred as it is to an emulsifying disperser (CAVITRON CD1010, Eurotech Ltd.) at a rate of 100 g/min. Separately, dilute aqueous ammonia having a concentration of 0.37% obtained by diluting the reagent aqueous ammonia with deionized water is put in a tank and transferred to an emulsifying disperser together with the amorphous polyester resin at a rate of 0.1 L/min while being heated at 120° C. by a heat exchanger. The emulsifying disperser is operated under the conditions of a rotation speed of a rotor of 60 Hz and a pressure of 5 kg/cm², thereby obtaining an amorphous polyester resin dispersion (A1) having a volume-average particle size of 160 nm and a solid content of 20%.

### Production of Crystalline Polyester Resin Dispersion (C1)

Decanedioic acid: 81 parts
Hexanediol: 47 parts

The above-described materials are put in a flask, the temperature is raised to 160° C. for 1 hour, and after it is confirmed that the inside of the reaction system is uniformly agitated, 0.03 parts of dibutyltin oxide is added. While the generated water is distilled off, the temperature is raised to 200° C. for 6 hours, and agitating is continued for 4 hours at 200° C. Thereafter, the reaction solution is cooled, solid-liquid separation is performed, and the solid is dried at a temperature of 40° C. under reduced pressure, thereby obtaining a crystalline polyester resin (C1) (melting point 64° C., weight-average molecular weight of 15,000).
Crystalline polyester resin (C1): 50 parts
Anionic surfactant (manufactured by DKS Co. Ltd., NEOGEN RK): 2 parts
Deionized water: 200 parts

The above-described materials are heated to 120° C., thoroughly dispersed with a homogenizer (ULTRA-TURRAX T50, IKA), and then subjected to a dispersion treatment with a pressure jet-type homogenizer. At a point in time when the volume-average particle size reaches 180 nm, the dispersed resultant is collected, thereby obtaining a crystalline polyester resin dispersion (C1) having a solid content of 20%.

### Production of Release Agent Particle Dispersion (W1)

Paraffin wax (HNP-9 manufactured by NIPPON SEIRO CO., LTD.): 100 parts
Anionic surfactant (manufactured by DKS Co. Ltd., NEOGEN RK): 1 part
Deionized water: 350 parts

The above materials are mixed together, heated to 100° C., and dispersed using a homogenizer (ULTRA-TURRAX T50 manufactured by IKA). By using a pressure jet-type Gorlin homogenizer, a dispersion treatment is performed, thereby obtaining a release agent particle dispersion in which release agent particles having a volume-average particle size of 200 nm are dispersed. Deionized water is added to the release agent particle dispersion such that the amount of solid content thereof is adjusted to 20%, thereby obtaining a release agent particle dispersion (W1).

### Production of Colorant Particle Dispersion (Y1)

Yellow pigment (C. I. Pigment Yellow 180): 50 parts
Anionic surfactant (manufactured by DKS Co. Ltd., NEOGEN RK): 5 parts
Deionized water: 195 parts

The above-described materials are mixed together and subjected to a dispersion treatment for 60 minutes by using a high-pressure impact disperser (ULTIMIZER HJP30006, SUGINO MACHINE LIMITED), thereby obtaining a colorant particle dispersion (K1) having an amount of solid content of 20%.

### Production of Yellow Toner Particles (Y1)

Deionized water: 200 parts
Amorphous polyester resin dispersion (A1): 150 parts
Crystalline polyester resin dispersion (C1): 10 parts
Release agent particle dispersion (W1): 10 parts
Colorant particle dispersion (Y1): 15 parts
Anionic surfactant (TaycaPower): 2.8 parts

The above materials are put in a round stainless steel flask, 0.1N nitric acid is added thereto to adjust the pH to 3.5, and then an aqueous polyaluminum chloride solution obtained by dissolving 2 parts of polyaluminum chloride (manufactured by Oji Paper Co., Ltd., 30% powder product) in 30 parts of deionized water is added thereto. The obtained solution is dispersed at 30° C. by using a homogenizer (ULTRA-TURRAX T50 manufactured by IKA), heated to 45° C. in an oil bath for heating, and retained until the volume-average particle size reaches 4.9 μm. Next, 60 parts of the amorphous polyester resin dispersion (A1) is added thereto, and the mixture is retained for 30 minutes. Thereafter, at a point in time when the volume-average particle size reaches 5.2 μm, 60 parts of the amorphous polyester resin dispersion (A1) is further added thereto, and the mixture is retained for 30 minutes. Subsequently, 20 parts of a 10% aqueous solution of NTA (nitrilotriacetic acid) metal salt (CHELEST 70, manufactured by CHELEST CORPORATION) is added thereto, and a 1N aqueous sodium hydroxide solution is added thereto to adjust the pH to 9.0. Next, 1 part of an anionic surfactant (TaycaPower) is added thereto, and the mixture is heated to 85° C. while being continuously agitated and retained for 5 hours. Next, the mixture is cooled to 20° C. at a rate of 20° C./min. Thereafter, the mixture is filtered, thoroughly washed with deionized water, and dried, thereby obtaining yellow toner particles (Y1) having a volume-average particle size of 5.7 μm and an average circularity of 0.971.

Subsequently, silica (SiO₂) particles having an average primary particle size of 40 nm, that has been subjected to a surface hydrophobic treatment with hexamethyldisilazane (hereinafter, may be abbreviated as “HMDS”), and metatitanic acid compound particles having an average primary particle size of 20 nm, that is a reaction product of metatitanic acid and isobutyltrimethoxysilane, are added to the yellow toner particles (Y1) such that a coverage of the surface of the toner particles is 40%, and the mixture is mixed with a Henschel mixer to produce a yellow toner (Y1).

### Preparation of Mixed Solution 1

Lacquer (solution obtained by mixing 20 parts of polycyclohexyl methacrylate (weight-average molecular weight: 68,000, glass transition temperature Tg: 110° C.) and 80 parts of toluene): 100 parts
Carbon black (average particle size: 0.2 μm): 0.2 parts

The above materials are charged into a sand mill, and dispersed for 30 minutes to obtain a mixed solution 1.

### Example 1

Ferrite core (volume-average particle size: 35 μm): 100 parts
Mixed solution 1: amount of resin solid content of 3.0 parts with respect to 100 parts of the ferrite core

The above components are charged into a batch-type agitating vacuum mixer (50 L kneader manufactured by INOUE MFG., INC., diameter D of agitating blade=0.25 m, clearance/D between the outer peripheral surface of the blade and the inner wall of the casing=3.5%) that has been warmed to a jacket temperature of 90° C., and the mixture is pre-heated (heated) to 70° C. while being agitated and mixed at 60 rpm. Next, the internal pressure of the mixer is reduced to 5 kPa-abs, and the load power value of the agitating blade before drying of the solvent is increased as the drying proceeds and is continued until, as the drying is completed, the load power value is decreased to 1.3 times or less the value before the drying, thereby forming resin-coated magnetic particles in which a resin coating layer is formed on a surface of the magnetic particles. In the case, the temperature of the obtained resin-coated magnetic particles rises to 98° C. Next, the resin-coated magnetic particles are crushed in a mixer for 30 minutes in a state in which the temperature of the resin-coated magnetic particles is maintained at 100° C. Crushing conditions of the resin-coated magnetic particles are described in Table 1.

Subsequently, the agitating of the mixer is stopped, and the crushed resin-coated magnetic particles are directly charged from the mixer to a fluidized bed equipment (manufactured by OKAWARA MFG. CO., LTD., Slit Flow). In the fluidized bed equipment, a fluidizing gas heated to 100° C. is jetted at a superficial velocity of 20 mm/s (2 times the value of the minimum fluidization velocity Umf), and the resin-coated magnetic particles are fluidized for 60 minutes while maintaining the temperature at 100° C. Next, a fluidizing gas at 20° C. is jetted at a superficial velocity of 100 mm/s (10 times the value of the minimum fluidization velocity Umf), and the resin-coated magnetic particles are cooled for 80 minutes to lower the temperature of the resin-coated magnetic particles to 70° C. Thereafter, the resin-coated magnetic particles are taken out from the fluidized bed equipment and sieved at a mesh opening size of 75 μm to produce a carrier 1. Fluidizing conditions and cooling conditions in the fluidized bed equipment are described in Table 1.

TABLE 1

| | | Step A: crushing conditions | | | | | | | | | | |
|---|---|---|---|---|---|---|---|---|---|---|---|---|
| | | | | | Agitating | | | | | | | |
| | | | | | work | | Step B: fluidizing | | | | | |
| | | | | Circumfer- | amount | | conditions | | | Step C: cooling conditions | | |
| | | Rotation | | ential | (circumfer- | | | | Superficial | | Superficial | Cooling |
| | | speed N | | speed | ential | | | | velocity | | velocity | temperature |
| | | of | | πDN of | speed | Temper- | Temper- | Fluid- | V_{H} | | V_{C} | T_{C} |
| | | agitating | Agitating | agitating | πDN × | ature | ature | izing | (multiplier | Cooling | (multiplier | (reaching |
| | Carrier | blade | time T | blade | agitating | T_{A} | T_{B} | time | for Umf) | time | for Umf) | temperature) |
| | No. | rpm | min | m/s | time T) | ° C. | ° C. | min | times | min | times | ° C. |
| Example 1 | 1 | 40 | 30 | 0.52 | 942 | 102 | 100 | 60 | 2 | 80 | 10 | 70 |
| Example 2 | 2 | 40 | 30 | 0.52 | 942 | 98 | 90 | 60 | 2 | 60 | 10 | 65 |
| Example 3 | 3 | 40 | 30 | 0.52 | 942 | 99 | 150 | 60 | 2 | 90 | 10 | 68 |
| Example 4 | 4 | 40 | 45 | 0.52 | 1,414 | 105 | 100 | 60 | 2 | 60 | 10 | 69 |
| Example 5 | 5 | 40 | 18 | 0.52 | 565 | 95 | 100 | 60 | 2 | 60 | 10 | 70 |
| Example 6 | 6 | 60 | 20 | 0.79 | 942 | 103 | 100 | 60 | 2 | 60 | 10 | 68 |
| Example 7 | 7 | 60 | 15 | 0.79 | 707 | 101 | 100 | 60 | 2 | 60 | 10 | 68 |
| Example 8 | 8 | 40 | 30 | 0.52 | 942 | 101 | 100 | 30 | 2 | 60 | 10 | 70 |
| Example 9 | 9 | 40 | 30 | 0.52 | 942 | 101 | 100 | 60 | 5 | 60 | 10 | 69 |
| Example 10 | 10 | 40 | 60 | 0.52 | 1,885 | 107 | 100 | 60 | 2 | 60 | 10 | 70 |
| Example 11 | 11 | 15 | 80 | 0.20 | 942 | 99 | 100 | 60 | 2 | 60 | 10 | 69 |
| Example 12 | 12 | 150 | 8 | 1.96 | 942 | 90 | 100 | 60 | 2 | 60 | 10 | 69 |
| Example 13 | 13 | 40 | 30 | 0.52 | 942 | 99 | 100 | 25 | 2 | 60 | 10 | 63 |
| Example 14 | 14 | 40 | 20 | 0.52 | 628 | 100 | 100 | 60 | 6 | 60 | 10 | 69 |
| Example 15 | 15 | 40 | 30 | 0.52 | 942 | 102 | 100 | 60 | 2 | 30 | 10 | 80 |
| Example 16 | 16 | 40 | 30 | 0.52 | 942 | 93 | 90 | 60 | 2 | 80 | 10 | 70 |
| Comparative | C1 | 40 | 90 | 0.52 | 2,827 | 70 | — | — | — | — | — | — |
| Example 1 | | | | | | | | | | | | |
| Comparative | C2 | 40 | 30 | 0.52 | 942 | 100 | 85 | 60 | 2 | 60 | 10 | 60 |
| Example 2 | | | | | | | | | | | | |
| Comparative | C3 | 40 | 30 | 0.52 | 942 | 102 | 165 | 60 | 2 | 120 | 10 | 70 |
| Example 3 | | | | | | | | | | | | |

### Examples 2 to 15

Carriers 2 to 15 are produced in the same manner as in Example 1, except that one or more of the crushing conditions of the resin-coated magnetic particles in the step A, the fluidizing conditions of the resin-coated magnetic particles in the step B, and the cooling conditions in the step C are changed as shown in Table 1 above.

### Example 16

### Preparation of Mixed Solution 2

Lacquer (solution obtained by mixing 20 parts of polycyclohexyl methacrylate (weight-average molecular weight: 50,000, glass transition temperature Tg: 100° C.) and 80 parts of toluene): 100 parts
Carbon black (average particle size: 0.2 μm): 0.2 parts

The above materials are charged into a sand mill, and dispersed for 30 minutes to obtain a mixed solution 2.

A carrier 16 is produced in the same manner as in Example 1, except that the mixed solution 2 is used and the conditions are as shown in Table 1 above.

### Comparative Example 1

Ferrite core (volume-average particle size: 35 μm): 100 parts
Mixed solution 1: amount of resin solid content of 3.0 parts with respect to 100 parts of the ferrite core

The above components are charged into a batch-type agitating vacuum mixer (50 L kneader manufactured by INOUE MFG., INC., diameter D of agitating blade=0.25 m, clearance/D between the outer peripheral surface of the blade and the inner wall of the casing=3.5%) that has been warmed to a jacket temperature of 90° C., and the mixture is pre-heated (heated) to 70° C. while being agitated and mixed at 60 rpm. Next, the internal pressure of the mixer is reduced to 5 kPa-abs, and the load power value of the agitating blade before drying of the solvent is increased as the drying proceeds and is continued until, as the drying is completed, the load power value is decreased to 1.3 times or less the value before the drying, thereby forming resin-coated magnetic particles in which a resin coating layer is formed on a surface of the magnetic particles. In the case, the temperature of the obtained resin-coated magnetic particles rises to 98° C. Next, a jacket temperature of the mixer is cooled to 20° C., and the resin-coated magnetic particles are cooled to 70° C. while the resin-coated magnetic particles are crushed for 90 minutes. Thereafter, the resin-coated magnetic particles are taken out from the mixer and sieved at a mesh opening size of 75 μm to produce a carrier C1.

Crushing conditions in the mixer are described in Table 1.

### Comparative Example 2

A carrier C2 is produced in the same manner as in Example 1, except that, in the step B, the resin-coated magnetic particles are fluidized for 60 minutes while maintaining the temperature at 85° C., and in the step C, the resin-coated magnetic particles are cooled for 60 minutes to lower the temperature of the resin-coated magnetic particles to 60° C.

### Comparative Example 3

A carrier C3 is produced in the same manner as in Example 1, except that, in the step B, the resin-coated magnetic particles are fluidized for 60 minutes while maintaining the temperature at 165° C., and in the step C, the resin-coated magnetic particles are cooled for 120 minutes to lower the temperature of the resin-coated magnetic particles to 70° C.

### Production of Developer

Any one of the carriers 1 to 16 and C1 to C3 and the yellow toner (Y1) are put into a V blender in a mixing ratio of carrier: toner=100:10 (mass ratio), and agitated for 20 minutes to obtain each of developers 1 to 16 and C1 to C3.

### Various Measurements and Evaluations

### Measurement of Coverage of Resin Coating Layer in Carrier

The coverage of the resin coating layer on the surface of the carrier is determined by an X-ray photoelectron spectroscopy (XPS) from the following method.

A target carrier and magnetic particles obtained by removing the resin coating layer from the target carrier are prepared. As a method of removing the resin coating layer from the carrier, a method of dissolving the resin component with toluene to remove the resin coating layer is used. The carrier and the magnetic particles excluding the resin coating layer are used as measurement samples, and Fe, C, and O (atomic %) are quantified by XPS, (Fe of carrier)+ (Fe of magnetic particles)×100 is calculated to obtain an exposed proportion (%) of the magnetic particles, and (100−Exposed proportion of magnetic particles) is adopted as the coverage (%) of the resin coating layer.

### Measurement of Amount of Free Resin in Carrier

The carrier is weighed in a specific amount and dispersed in water, and the dispersion is filtered while fixing the carrier with a magnet. The filter paper is dried, and the amount of free resin is calculated from a difference in mass of the filter paper before and after the drying and the amount of carrier weighed.

Measurement of Proportion of Aggregates After Classification with Sieve of 75 μm in Carrier

The carrier is sieved with a sieve having an opening size of 75 μm, the sieved carriers are spread so as not to overlap as much as possible, and a scanning electron microscope (SEM) photograph at a magnification of 350 times is taken, and a proportion of the number of carriers not crushed into primary particles to the number of carriers in one field of view is measured.

### Evaluation of Color Haze Suppression Property

Color haze is evaluated as follows.

One piece of a patch of a solid image of 5 cm×5 cm (sample 1) is output using the 700 Digital Color Press (manufactured by FUJIFILM Business Innovation Corp.) filled with the obtained developer, an image with an area coverage of 5% is output 100,000 times, and then one piece of a patch of a solid image of 5 cm×5 cm (sample 2) is output again. A color gamut (L*, a*, b*) of the sample 1 and the sample 2 is measured. The color gamut is measured with an image densitometer X-RITE 938 (manufactured by X-RITE).

From the difference between the color gamut of the sample 2 and the color gamut of the sample 1, ΔE is calculated using the following expression, and used as an index for evaluating the color haze.

$$Δ E = {[ {( Δ {L}^{*} )}^{2} + {( Δ {a}^{*} )}^{2} + {( Δ {b}^{*} )}^{2} ]}^{1 / 2}$$

Here, ΔL*=(L′ of sample 2−L′ of sample 1), Aa*=(a* of sample 2−a* of sample 1), and Ab*=(b* of sample 2−b* of sample 1).

The evaluation standard is as follows.

### Evaluation Standard

G1: ΔE≤1.0

$$G 2 : 1. < Δ E \leq 2.$$

$$G 3 : 2. < Δ E \leq 3.$$

$$G 4 : 3. < Δ E \leq 5.$$

$$G 5 : 5. < Δ E \leq 7.$$

$$G 6 : 7. < Δ E \leq 10 \text{.0}$$

G7: 10.0<ΔE

The results of the measurements and evaluations are collectively shown in Table 2.

TABLE 2

| | | Physical properties of carrier | | | | |
|---|---|---|---|---|---|---|
| | | | | | Proportion of | Evaluation |
| | | Amont of resin | Coverage of resin | Amount of free | aggregates after | Evaluation of |
| | Carrier | coating layer | coating layer | resin | classification | color haze |
| | No | % by mass | % | ppm | % by number | G1 to G7 |
| Example 1 | 1 | 2.96 | 91 | 15 | 0 | G1 |
| Example 2 | 2 | 2.95 | 90 | 52 | 0 | G4 |
| Example 3 | 3 | 2.98 | 92 | 79 | 0 | G4 |
| Example 4 | 4 | 2.99 | 90 | 84 | 0 | G3 |
| Example 5 | 5 | 2.97 | 90 | 68 | 1 | G3 |
| Example 6 | 6 | 2.98 | 91 | 21 | 0 | G1 |
| Example 7 | 7 | 2.98 | 91 | 18 | 0 | G1 |
| Example 8 | 8 | 2.99 | 90 | 38 | 0 | G2 |
| Example 9 | 9 | 2.99 | 90 | 33 | 0 | G2 |
| Example 10 | 10 | 2.98 | 92 | 254 | 0 | G4 |
| Example 11 | 11 | 2.98 | 92 | 58 | 38 | G4 |
| Example 12 | 12 | 2.92 | 92 | 99 | 0 | G4 |
| Example 13 | 13 | 2.94 | 91 | 88 | 0 | G3 |
| Example 14 | 14 | 2.98 | 85 | 75 | 0 | G3 |
| Example 15 | 15 | 2.96 | 91 | 35 | 0 | G2 |
| Example 16 | 16 | 2.96 | 91 | 48 | 0 | G3 |
| Comparative | C1 | 2.94 | 88 | 350 | 0 | G6 |
| Example 1 | | | | | | |
| Comparative | C2 | 2.98 | 90 | 305 | 0 | G5 |
| Example 2 | | | | | | |
| Comparative | C3 | 2.97 | 82 | 856 | 0 | G7 |
| Example 3 | | | | | | |

From the above-described results, it is found that Examples have excellent color haze suppression property of the image to be obtained as compared with Comparative Examples.

Hereinafter, aspects of the present disclosure will be described.

(((1))) A manufacturing method of an electrostatic charge image developing carrier, comprising:
a step A in which a mixed solution containing a resin having a glass transition temperature Tg and a solvent is mixed with magnetic particles in a mixer, the mixture is heated to evaporate the solvent to form a resin coating layer on a surface of the magnetic particles so that resin-coated magnetic particles are obtained, and the resin-coated magnetic particles are crushed in a state of being maintained at a temperature T_{A};
a step B in which the resin-coated magnetic particles after the step A are fluidized in a fluidized bed equipment in a state of being maintained at a temperature T_{B}, and
a step C in which the resin-coated magnetic particles after the step B are cooled, wherein the temperature T_{A} and the temperature T_{B} are each independently equal to or higher than the glass transition temperature Tg−20° C. and equal to or lower than the glass transition temperature Tg+50° C.

(((2))) The manufacturing method of an electrostatic charge image developing carrier according to (((1))),
wherein, in the step A, a mixer having an agitating blade is used, and an agitating condition in the mixer during the crushing of the resin-coated magnetic particles in the state of being maintained at the temperature T_{A} satisfies requirements of the following expression 1 and the following expression 2,

0.2≤a circumferential speed πDN (m/s) of the agitating blade≤2.0 expression 1,

5×10²<an agitating work amount (the circumferential speed πDN×an agitating time T)≤1.5 ×10³ expression 2,
in the expressions 1 and 2, D represents a diameter (m) of the agitating blade, N represents a rotation speed (rps) of the agitating blade, and T represents a time(s) from a point in time when a load power value of the agitating blade before drying of the solvent rises as the drying proceeds, and as the drying is completed, the load power value is decreased to 1.3 times or less a value before the drying, to a point in time when the agitating in the mixer is terminated.

(((3))) The manufacturing method of an electrostatic charge image developing carrier according to (((2))),
wherein the requirement of the expression 2 is a requirement of the following expression 2′,

7×10²≤the agitating work amount (the circumferential speed πDN×the agitating time T)≤1 ×10³ expression 2′,
in the expression 2′, D represents the diameter (m) of the agitating blade, N represents the rotation speed (rps) of the agitating blade, and T represents the time(s) from a point in time when the load power value of the agitating blade before drying of the solvent rises as the drying proceeds, and as the drying is completed, the load power value is decreased to 1.3 times or less the value before the drying, to a point in time when the agitating in the mixer is terminated.

(((4))) The manufacturing method of an electrostatic charge image developing carrier according to any one of (((1))) to (3))),
wherein, in the step B, the resin-coated magnetic particles after the step A are fluidized for 30 minutes or longer in the state of being maintained at the temperature T_{B}, and
in the step C, the resin-coated magnetic particles are cooled to a temperature Tc of equal to or lower than the glass transition temperature Tg−40° C.

(((5))) The manufacturing method of an electrostatic charge image developing carrier according to any one of (((1))) to (((4))),
wherein, in the step B, a superficial velocity V_{H} (m/s) of a fluidizing gas in the fluidized bed equipment during the fluidizing of the resin-coated magnetic particles after the step A in the state of being maintained at the temperature T_{B} satisfies 1 times or more and 5 times or less a minimum fluidization velocity Umf.

(((6))) The manufacturing method of an electrostatic charge image developing carrier according to (((5))),
wherein the superficial velocity V_{H} of the fluidizing gas in the fluidized bed equipment satisfies 2 times or more and 3 times or less the minimum fluidization velocity Umf.

(((7))) A manufacturing method of an electrostatic charge image developer, comprising:
the manufacturing method of an electrostatic charge image developing carrier according to any one of (((1))) to ((6))

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A manufacturing method of an electrostatic charge image developing carrier, comprising:
a step A in which a mixed solution containing a resin having a glass transition temperature Tg and a solvent is mixed with magnetic particles in a mixer, the mixture is heated to evaporate the solvent to form a resin coating layer on a surface of the magnetic particles so that resin-coated magnetic particles are obtained, and the resin-coated magnetic particles are crushed in a state of being maintained at a temperature T_{A};
a step B in which the resin-coated magnetic particles after the step A are fluidized in a fluidized bed equipment in a state of being maintained at a temperature T_{B}, and
a step C in which the resin-coated magnetic particles after the step B are cooled,
wherein the temperature T_{A} and the temperature T_{B} are each independently equal to or higher than the glass transition temperature Tg−20° C. and equal to or lower than the glass transition temperature Tg+50° C.

2. The manufacturing method of an electrostatic charge image developing carrier according to claim 1,
wherein, in the step A, a mixer having an agitating blade is used, and an agitating condition in the mixer during the crushing of the resin-coated magnetic particles in the state of being maintained at the temperature T_{A} satisfies requirements of the following expression 1 and the following expression 2,
0.2≤a circumferential speed πDN (m/s) of the agitating blade≤2.0 expression 1,
5×10²≤an agitating work amount (the circumferential speed πDN×an agitating time T)≤1.5×10³ expression 2,
in the expressions 1 and 2, D represents a diameter (m) of the agitating blade, N represents a rotation speed (rps) of the agitating blade, and T represents a time(s) from a point in time when a load power value of the agitating blade before drying of the solvent rises as the drying proceeds, and as the drying is completed, the load power value is decreased to 1.3 times or less a value before the drying, to a point in time when the agitating in the mixer is terminated.

3. The manufacturing method of an electrostatic charge image developing carrier according to claim 2,
wherein the requirement of the expression 2 is a requirement of the following expression 2′,
7×10²≤the agitating work amount (the circumferential speed πDN×the agitating time T)≤1×10³ expression 2′,
in the expression 2′, D represents the diameter (m) of the agitating blade, N represents the rotation speed (rps) of the agitating blade, and T represents the time(s) from a point in time when the load power value of the agitating blade before drying of the solvent rises as the drying proceeds, and as the drying is completed, the load power value is decreased to 1.3 times or less the value before the drying, to a point in time when the agitating in the mixer is terminated.

4. The manufacturing method of an electrostatic charge image developing carrier according to claim 1,
wherein, in the step B, the resin-coated magnetic particles after the step A are fluidized for 30 minutes or longer in the state of being maintained at the temperature T_{B}, and
in the step C, the resin-coated magnetic particles are cooled to a temperature Tc of equal to or lower than the glass transition temperature Tg−40° C.

5. The manufacturing method of an electrostatic charge image developing carrier according to claim 1,
wherein, in the step B, a superficial velocity V_{H} (m/s) of a fluidizing gas in the fluidized bed equipment during the fluidizing of the resin-coated magnetic particles after the step A in the state of being maintained at the temperature T_{B} satisfies 1 times or more and 5 times or less a minimum fluidization velocity Umf.

6. The manufacturing method of an electrostatic charge image developing carrier according to claim 5,
wherein the superficial velocity V_{H} of the fluidizing gas in the fluidized bed equipment satisfies 2 times or more and 3 times or less the minimum fluidization velocity Umf.

7. A manufacturing method of an electrostatic charge image developer, comprising:
the manufacturing method of an electrostatic charge image developing carrier according to claim 1.

8. A manufacturing method of an electrostatic charge image developer, comprising:
the manufacturing method of an electrostatic charge image developing carrier according to claim 2.

9. A manufacturing method of an electrostatic charge image developer, comprising:
the manufacturing method of an electrostatic charge image developing carrier according to claim 3.

10. A manufacturing method of an electrostatic charge image developer, comprising:
the manufacturing method of an electrostatic charge image developing carrier according to claim 4.

11. A manufacturing method of an electrostatic charge image developer, comprising:
the manufacturing method of an electrostatic charge image developing carrier according to claim 5.

12. A manufacturing method of an electrostatic charge image developer, comprising:
the manufacturing method of an electrostatic charge image developing carrier according to claim 6.
